(19) United States
(12) Patent Application Publication
(10) Pub. No.: US 2014/0127595 A1
(43) Pub. Date: May 8, 2014

(54) AIR ELECTRODE FOR AIR BATTERY, AND AIR BATTERY

(71) Applicant: Yutaka HIROSE, Susono-shi (JP)

(72) Inventor: Yutaka HIROSE, Susono-shi (JP)

(73) Assignee: Toyota Jidosha Kabushiki Kaisha, Toyota-shi (JP)

(21) Appl. No.: 14/069,828

(22) Filed: Nov. 1, 2013

(30) Foreign Application Priority Data
Nov. 5, 2012 (JP) 2012-243823

(51) Int. Cl. H01M 4/86; H01M 12/08

(52) U.S. Cl. CPC H01M 4/8663; H01M 12/08
USPC 429/405

(57) ABSTRACT

An air electrode for use in an air battery includes at least a conductive material and an inorganic fluoride, with the inorganic fluoride being included in a ratio of from 11 to 22 wt % per 100 wt % of the conductive material and the inorganic fluoride combined.

### INCORPORATION BY REFERENCE

The disclosure of Japanese Patent Application No. 2012-243823 filed on Nov. 5, 2012 including the specification, drawings and abstract is incorporated herein by reference in its entirety.

### BACKGROUND OF THE INVENTION

1. Field of the Invention

The invention relates to an air electrode which, when used in an air battery, can make the current density of the battery higher than that in a conventional air battery. The invention also relates to an air battery.

2. Description of Related Art

An air battery is a battery which can be charged and discharged and in which a metal alone or a metal compound is used as the negative electrode active material and oxygen is used as the positive electrode active material. Because the oxygen which serves as the positive electrode active material can be obtained from the air, a positive electrode active material need not be included within the battery. Hence, an air battery can, in theory, achieve a larger capacity than a secondary battery which uses a solid positive electrode active material.

In a lithium-air battery, which is one type of air battery, during discharge, the reaction of formula (I) below takes place at the negative electrode.

2Li→2Li⁺+2e⁻ (I)

The electrons that form in formula (I) follow an external circuit and do work at an external load, after which they reach an air electrode. The lithium ions (Li⁺) that form in formula (I) migrate by electro-osmosis from the negative electrode side to the air electrode side through an electrolyte held between the negative electrode and the air electrode.

In addition, during discharge, the reactions of formula (II) and formula (III) below take place at the air electrode.

2Li⁺+O₂+2e⁻→Li₂O₂ (II)

2Li⁺+½O₂+2e⁻→Li₂O (III)

The lithium peroxide (Li₂O₂) and lithium oxide (Li₂O) that have formed accumulate as solids at the air electrode. During charging, the reverse reaction of formula (I) above takes place at the negative electrode and the reverse reactions of formulas (II) and (III) take place at the air electrode, regenerating metallic lithium at the negative electrode, thereby making the battery capable of discharging again.

The compounding of a carbon material within the air electrode of an air battery in order to ensure electrical conductivity within the air electrode is available. Japanese Patent Application Publication No. 2012-113929 (JP 2012-113929 A) mentions, for example, mesoporous carbon as the carbon material used in the air electrode of an air battery (see paragraph [0039] of JP 2012-113929 A).

### SUMMARY OF THE INVENTION

JP 2012-113929 discloses a working example in which ketjen black (KB) as a conductive material, polytetrafluoroethylene (PTFE) as a binder and nickel (Ni) powder as the air electrode catalyst are mixed together in the ratio KB:PTFE:Ni=80 wt %:10 wt %:10 wt % to prepare an air electrode paste, and an air electrode is produced using this air electrode paste (see paragraphs [0058] and [0059] of JP 2012-113929 A). However, as a result of investigations, the inventor has found that there is a risk of low current density in air batteries of the sort disclosed in JP 2012-113929 A. In light of the above, the invention provides an air electrode which, when used in an air battery, is able to increase the current density to a higher level than that in conventional air batteries. The invention also provides an air battery equipped with such an air electrode.

The air electrode for an air battery according to the invention contains at least a conductive material and an inorganic fluoride, with the inorganic fluoride being included in a ratio of from 11 to 22 wt % per 100 wt % of the conductive material and the inorganic fluoride combined.

The air electrode of the invention may further include a binder and may include the inorganic fluoride in a ratio of from 10 to 20 wt % per 100 wt % of the conductive material, the inorganic fluoride and the binder combined.

In this invention, the inorganic fluoride may be at least one compound selected from the group consisting of aluminum fluoride (AlF₃), silicon fluoride (SiF₄), iron(III) fluoride (FeF₃), calcium fluoride (CaF₂), MgF₂ and titanium(IV) fluoride (TiF₄).

The air battery includes at least an air electrode, a negative electrode, and an electrolyte layer interposed between the air electrode and the negative electrode. The air electrode used here is the foregoing air electrode for an air battery.

In this invention, the air electrode includes a conductive material and an inorganic fluoride in optimal proportions, which promotes the supply of oxygen to the air electrode. This feature can make the current density of the battery higher than that in a conventional air battery in the use in an air battery,

### BRIEF DESCRIPTION OF THE DRAWINGS

Features, advantages, and the technical and industrial significance of exemplary embodiments of the invention will be described below with reference to the accompanying drawings, in which like numerals denote like elements, and wherein:

FIG. 1 is a schematic sectional view showing an example of the layer construction of the air battery according to one embodiment of the invention; and

FIG. 2 shows discharge curves for the lithium-air batteries of Examples 1 and 2 according to the invention and Comparative Examples 1 to 3.

### DETAILED DESCRIPTION OF EMBODIMENTS

1. Air Electrode for Air Battery

The air electrode for an air battery according to one embodiment of the invention contains at least a conductive material and an inorganic fluoride. The inorganic fluoride is included in a ratio of from 11 to 22 wt % per 100 wt % of the conductive material and the inorganic fluoride combined.

As was mentioned in JP 2012-113929 A, the discharge reaction rate of a conventional air battery in which a carbon material is used as the air electrode is generally at least one order of magnitude slower than the discharge reaction rate of a conventional secondary battery such as a lithium ion battery. One reason given for the slow discharge reaction rate is insufficient diffusion of oxygen in the air electrode of the air battery. The inventor has discovered that the diffusion of oxygen within the air electrode is promoted by mixing within the air electrode an inorganic fluoride which can be expected to molecularly bond with oxygen. The inventor has found that by including a specific ratio of inorganic fluoride within the air electrode, the current density can be made higher than that of a conventional air battery, and developed this invention.

Fluorine (F) generally has the property of bonding weakly with oxygen (O). Therefore, by including a fluoride in the air electrode, instead of being unevenly distributed, the oxygen spreads uniformly throughout the air electrode, enabling the oxygen diffusibility of the air electrode to be increased. As noted in JP 2012-113929 A, the use of a fluorine-containing binder such as PTFE in the air electrode of a conventional air battery is a conventional feature. However, when the ratio of the binder included in the air electrode is increased in order to obtain the above oxygen-diffusing effect, the density of the air electrode rises, lowering the porosity of the air electrode, which may result in lower battery characteristics than in conventional secondary batteries. In the invention, by mixing into the air electrode an inorganic fluoride without bonding properties instead of an organic fluoride with bonding properties such as PTFE, oxygen supply and diffusion within the air electrode can be promoted while yet retaining porosity within the air electrode.

The air electrode according to an embodiment of the invention preferably has an air electrode layer, and typically has also an air electrode current collector and an air electrode lead connected to this air electrode current collector. The air electrode layer preferably used in this invention includes at least a conductive material and an inorganic fluoride. The air electrode layer may also optionally include, for example, a binder and a catalyst.

The conductive material used in an embodiment of the invention is not particularly limited so long as it has electrical conductivity. Illustrative examples include carbon materials, perovskite-type conductive materials, porous conductive polymers and porous metal bodies. The carbon material may be one having a porous structure or may be one without a porous structure, although a carbon material having a porous structure is preferred in this invention because the specific surface area is large, making it possible to provide many reaction sites. Carbon materials having a porous structure are exemplified by mesoporous carbon. Carbon materials without a porous structure are exemplified by graphite, acetylene black, carbon black, carbon nanotubes and carbon fibers. When a carbon material is used as the conductive material, the carbon material is preferably one having a high pore volume of at least 1 cc/g. Assuming the total weight of the air electrode layer to be 100 wt %, the ratio of the conductive material in the air electrode layer is preferably from 10 to 90 wt %, and more preferably from 50 to 80 wt %. If the content of the conductive material is too low, the number of reactive sites decreases, which may lower the battery capacity. On the other hand, if the content of the conductive material is too high, the catalyst content undergoes a relative decline, as a result of which a sufficient catalyst function may not be exhibited.

The inorganic fluoride used in an embodiment of the invention is not particularly limited, provided it is an inorganic compound having a fluorine atom (F) in the chemical structure thereof. By including an inorganic fluoride in the air electrode, the diffusibility of the reactant such as oxygen can be increased, even under high current density conditions, as a result of which the voltage can be maintained at a constant value. The inorganic fluoride used in the invention is preferably AlF₃, SiF₄, iron(III) FeF₃, CaF₂, magnesium fluoride (MgF₂) or IV TiF₄. These inorganic fluorides may be used singly or two or more may be used in combination. Of these inorganic fluorides, the use of AlF₃ is more preferred.

In an embodiment of the invention, the inorganic fluoride is included in a ratio of from 11 to 22 wt % per 100 wt % of the conductive material and the inorganic fluoride combined. At a ratio of inorganic fluoride below 11 wt %, the amount of inorganic fluoride is too low and so, as demonstrated in the subsequently described Comparative Example 2, a sufficient current density-improving effect may not be achievable. On the other hand, at an inorganic fluoride ratio greater than 22 wt %, the amount of inorganic fluoride is too high, leading conversely to a decrease in the ratio of the conductive material; the result, as demonstrated in the subsequent described Comparative Example 3, may be a decrease in battery capacity. The ratio of inorganic fluoride included per 100 wt % of the conductive material and the inorganic fluoride combined is preferably at least 13 wt %, and more preferably at least 15 wt %. The ratio of the inorganic fluoride is preferably not more than 20 wt %, and more preferably not more than 18 wt %.

Although it suffices for the above air electrode layer to include at least a conductive material and an inorganic fluoride, it is preferable for the air electrode layer to further include a binder which fixes in place the conductive material and the inorganic fluoride. Illustrative examples of binders include polyvinylidene fluoride (PVdF), PTFE, and rubbery resins such as styrene-butadiene (SBR) rubber. The ratio of binder included in the air electrode layer, although not particularly limited, is preferably from 1 to 60 wt %, and especially from 1 to 10 wt %, per 100 wt % of the total weight of the air electrode layer.

When a binder is included in the air electrode, it is preferable for the ratio of inorganic fluoride per 100 wt % of the conductive material, inorganic fluoride and binder combined to be from 10 to 20 wt %. At an inorganic fluoride ratio below 10 wt %, because the amount of inorganic fluoride is too low, as demonstrated in subsequently described Comparative Example 2, a sufficient current density-increasing effect may not be achievable. On the other hand, at an inorganic fluoride ratio greater than 20 wt %, because the amount of inorganic fluoride is too high, the ratio of conductive material conversely decreases; the result, as demonstrated in subsequently described Comparative Example 3, may be a decrease in battery capacity. The inorganic fluoride ratio per 100 wt % of the combined amount of conductive material, inorganic fluoride and binder is preferably at least 12 wt %, and more preferably at least 14 wt %; and is preferably not more than 18 wt %, and more preferably not more than 16 wt %.

The air electrode catalyst used in an embodiment of the invention is exemplified by oxygen-activating catalysts. Examples of oxygen-activating catalysts include platinum family metals such as Ni, palladium and platinum; perovskite-type oxides containing a transition metal such as cobalt, manganese or iron; inorganic compounds containing an oxide of a noble metal such as ruthenium, iridium or palladium; organometallic coordination compounds having a porphyrin skeleton or a phthalocyanine skeleton; and manganese oxide. The ratio of catalyst included in the air electrode layer is not particularly limited. For example, it may be set to from 0 to 90 wt %, and especially from 1 to 90 wt %, per 100 wt % of the air electrode layer as a whole. From the standpoint of more smoothly carrying out the electrode reactions, the catalyst may be supported on the conductive material described above.

Illustrative examples of the method of producing the air electrode layer include, but are not limited to, methods that involve mixing, then rolling, the starting materials for an air electrode layer containing the above conductive material; and methods that involve adding a solvent to these starting materials to prepare a slurry, then applying the slurry to the subsequently described air electrode current collector. Examples of methods for applying the slurry to an air electrode current collector include conventional methods such as spraying, screen printing, doctor blade coating, gravure printing, die coating and ink jet printing. When preparing the slurry in the production of the air electrode layer, it is preferable to use an organic solvent having a boiling point of 200° C. or less as the dispersion medium in the slurry. Illustrative examples of such organic solvents include acetone and N-methylpyrrolidone (NMP). The air electrode layer has a thickness which varies depending on, for example, the intended use of the air battery, but is preferably from 2 to 500 μm, and especially from 5 to 300 μm.

The air electrode current collector used in an embodiment of the invention carries out the collection of charge at the air electrode layer. The material used to make up the air electrode current collector is not particularly limited, provided it has electrical conductivity. Illustrative examples include stainless steel, Ni, aluminum, iron, titanium and carbon. With regard to shape, the air electrode current collector may be in the form of, for example, a foil, sheet or mesh (grid). Of these, to provide an excellent current collecting efficiency, the air electrode current collector in this invention is preferably in the form of a mesh. In such a case, a mesh-like air electrode current collection is generally disposed at the interior of the air electrode layer. The air battery in the embodiment of this invention may also have another air electrode current collector (e.g., a foil-like current collector) which collects electrical charge that has been collected by the mesh-like air electrode current collector. In the invention, the subsequently described battery case may function also as an air electrode current collector. The air electrode current collector has a thickness of preferably from 10 to 1,000 μm, and especially from 20 to 400 μm.

2. Air Battery

The air battery according to an embodiment of the invention is an air battery which includes at least an air electrode, a negative electrode and an electrolyte layer interposed between the air electrode and the negative electrode. The air electrode is characterized by being the above-described air electrode for air batteries.

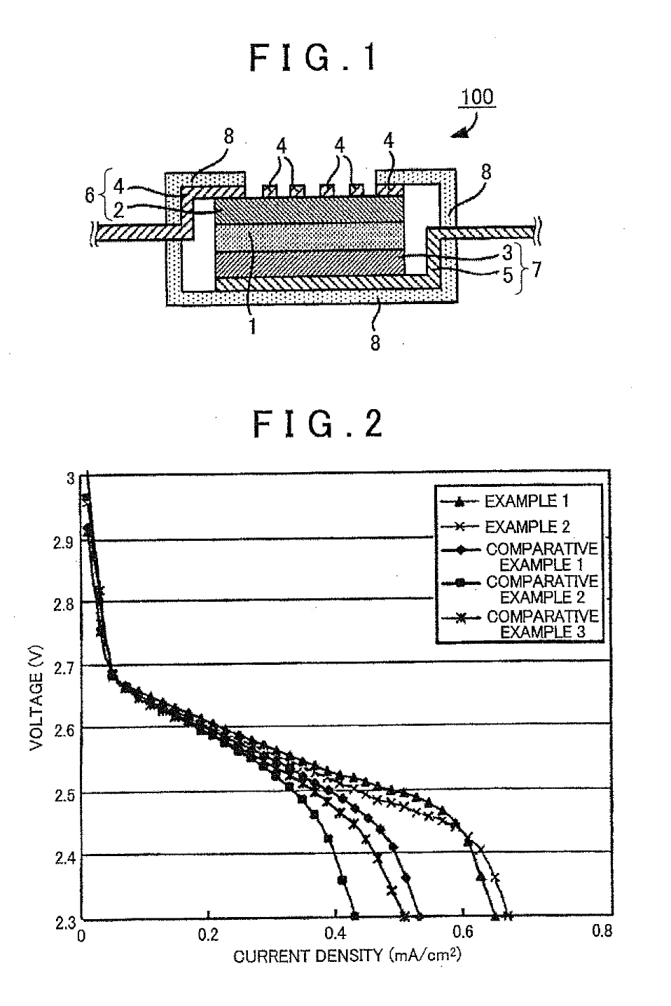

FIG. 1 is a schematic sectional view showing an example of the layer constriction of the air battery according to an embodiment of the invention. In FIG. 1, the double wavy lines indicate breaks in the diagram. It should be noted that the air battery according to the embodiment the invention is not necessarily limited only to this example. The air battery 100 has an air electrode 6 with an air electrode layer 2 and an air electrode current collector 4, a negative electrode 7 having a negative electrode active material layer 3 and a negative electrode current collector 5, an electrolyte layer 1 held between the air electrode 6 and the negative electrode 7, and a battery case 8 which houses the air electrode 6, the negative electrode 7 and the electrolyte layer 1. The presence of the air electrode current collector 4 at scattered locations in FIG. 1 indicates that part or all of the air electrode current collector 4 is in the form of a mesh. The battery case 8 has pores that substantially overlap mesh portions of the air electrode current collector 4. The air electrode used in the air battery of the invention is as described above. The negative electrode and electrolyte layer serving as other constituent members of the air battery of the invention, and the separator and battery case preferred for use in the embodiment of the inventive air battery, are described below in detail.

The negative electrode used in the invention preferably has a negative electrode active material layer containing a negative electrode active material, and generally also has a negative electrode current collector and a negative electrode lead connected to the negative electrode current collector.

The negative electrode active material layer used in this embodiment of the invention includes a negative electrode active material containing at least one selected from the group consisting of metal materials, alloy materials and carbon materials such as graphite. Illustrative examples of metals and alloy materials which may be used in the negative electrode active material include alkali metals such as lithium, sodium and potassium; Group 2 elements such as magnesium and calcium; Group 11 elements such as silver; Group 13 elements such as aluminum; transition metals such as zinc and iron; alloys containing these metals; and metal oxides, metal nitrides and metal sulfides containing these metals. Illustrative examples of lithium-containing alloys include lithium-aluminum alloys, lithium-tin alloys, lithium-lead alloys and lithium-silicon alloys. Illustrative examples of lithium-containing metal oxides include lithium titanium oxides. Examples of lithium-containing metal nitrides include lithium cobalt nitride, lithium iron nitride and lithium manganese nitride. Moreover, lithium coated with a solid electrolyte may also be used in the negative electrode active material layer.

The above negative electrode active material layer may contain only a negative electrode active material, or may contain a conductive material and/or a binder in addition to the negative electrode active material. For example, when the negative electrode active material is in the form of a foil, the negative electrode active material layer may include only a negative electrode active material. On the other hand, when the negative electrode active material is in the form of a powder, the negative electrode active material layer may include a negative electrode active material and a binder. The types of and content (ratio) of the binder are as described above.

The conductive material included in the negative electrode active material layer is not particularly limited, provided it has electrical conductivity. Illustrative examples include carbon materials, perovskite-type conductive materials, porous conductive polymers and metal porous bodies. The carbon material may be one having a porous structure, or may be one without a porous structure. Examples of carbon materials having a porous structure include mesoporous carbon. Specific examples of carbon materials without a porous structure include graphite, acetylene black, carbon nanatubes and carbon fibers.

The negative electrode current conductor material used in an embodiment of the invention is not particularly limited, provided it has electrical conductivity. Illustrative examples include copper, stainless steel, Ni and carbon. Of these, the use of stainless steel or Ni in the negative electrode current collector is preferred. With regard to shape, the negative electrode current collector may be in the form of, for example, a foil, sheet or mesh (grid). In the embodiment of the invention, the subsequently described battery case may function also as a negative electrode current collector.

The electrolyte used in an embodiment of the invention is held between the air electrode layer and the negative electrode active material layer, and has the function of exchanging metal ions between the air electrode layer and the negative electrode active material layer. An electrolyte solution, a gel electrolyte, a solid electrolyte or the like may be used in the electrolyte layer, These may be used singly, or two or more may be used in combination.

Aqueous electrolyte solutions and nonaqueous electrolyte solutions may be used as the electrolyte solution. It is preferable to suitably select the type of nonaqueous electrolyte solution according to the type of metal ion that is to be transported. For example, nonaqueous electrolyte solutions used in lithium air batteries are generally ones which contain a lithium salt and a nonaqueous solvent. Illustrative examples of the lithium salt include inorganic lithium salts such as LiPF₆, LiBF₄, LiClO₄ and LiAsF₆; and organic lithium salts such as LiCF₃SO₃, LiN(SO₂CF₃)₂(Li-TFSA), LiN(SO₂C₂F₅)₂ and LiC(SO₂CF₃)₃. Illustrative examples of the nonaqueous solvent include ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolaetone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethylsulfoxide (DMSO) and mixtures thereof. The concentration of lithium salt in the nonaqueous electrolyte solution is, for example, from 0.5 to 3 mol/L.

The nonaqueous electrolyte solution or nonaqueous solvent used in an embodiment of the invention as the nonaqueous electrolyte solution or nonaqueous solvent may be a low-volatility liquid, illustrative examples of which include the following ionic liquids: N-methyl-N-propylpiperidinium bis(trifluoromethanesulfonyl)amide (PP13TFSA), N-methyl-N-propylpyrrolidinium bis(trifluoromethanesulfonyl)amide (P13TFSA), N-butyl-N-methylpyrrolidinium bis(trifluoromethanesulfonyl)amide (P14TFSA), N,N-diethyl-N-methyl-N-(2-methoxyethyl)ammonium bis(trifluoromethanesulfonyl)amide (DEMETFSA) and N,N,N-trimethyl-N-propylammonium bis(trifluoromethanesulfonyl)amide (TMPATFSA). Of these nonaqueous solvents, the use of an electrolyte solution solvent which is stable to oxygen radicals is more preferred for inducing the oxygen reducing reaction of above formula (II) or (III) to proceed. Examples of such nonaqueous solvents include acetonitrile (AcN), 1,2-dimethoxyethane (DME), dimethylsulfoxide (DMSO), N-methyl-N-propylpiperidinium bis(trifluoromethanesulfonyl)amide (PP13TFSA), N-methyl-N-propylpyrrolidinium bis(trifluoromethanesulfonyl)amide (P13TFSA) and N-butyl-N-methylpyrrolidinium bis(trifluoromethanesulfonyl)amide (P14TFSA). These nonaqueous solvents are able, by virtue of their high oxygen radical resistance, to suppress side reactions other than the target oxygen-reducing reaction.

It is preferable for the type of aqueous electrolyte solution to be suitably selected according to the type of metal ions to be transported. For example, a solution containing a lithium salt and water is generally used as the aqueous electrolyte solution employed in lithium-air batteries. Illustrative examples of the lithium salt include LiOH, LiCl, LiNO₃ and CH₃CO₂Li.

The gel electrolyte used in an embodiment of the invention is generally one that has been obtained by the addition of a polymer to a nonaqueous electrolyte solution and gelation. For example, the nonaqueous gel electrolyte of a lithium-air battery is obtained by adding polyethylene oxide (PEO), polyacrylonitrile (PAN) or polymethyl methacrylate (PMMA) to the above-described nonaqueous electrolyte solution, followed by gelation. In the invention, a PEO/LiTFSA (LiN(CF₃SO₂)₂) based nonaqueous gel electrolyte is preferred.

Examples of solid electrolytes that may be used include sulfide-based solid electrolytes, oxide-based solid electrolytes and polymer electrolytes. Illustrative examples of sulfide-based solid electrolytes include Li₂S'P₂S₅, Li₂S—P₂S₃, Li₂S—P₂S₃—P₂S₅, Li₂S—SiS₂, Li₂S—Si₂S, Li₂S—B₂S₃, Li₂S—GeS₂, LiI—Li₂S—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄ and Li₄₋ₓGe₁₋ₓPₓS₄. Illustrative examples of oxide-based solid electrolytes include LiPON (lithium phosphate oxynitride), Li_{1.3}Al_{0.3}Ti_{0.7}(PO₄)₃, La_{0.51}Li_{0.34}TiO_{0.74}, Li₃PO₄, Li₂SiO₂ and Li₂SiO₄. It is preferable to suitably select the polymer electrolyte according to the type of metal ion to be transported. For example, the polymer electrolyte in a lithium-air battery generally contains a lithium salt and a polymer. At least one of the above-mentioned inorganic lithium salts and organic lithium salts may be used as the lithium salt, The polymer is not particularly limited, so long as it is one that forms a complex with a lithium salt. Examples include polyethylene oxides.

The air battery according to an embodiment of the invention may have a separator between the air electrode and the negative electrode. Illustrative examples of the separator include porous membranes made of a polyolefin such as polyethylene and polypropylene, and nonwoven fabrics such as nonwoven fabrics made of a resin (e.g., polypropylene) and nonwoven fabrics made of glass fibers. These materials which are capable of being used in the separator can also be employed as a support for the electrolyte solution by being impregnated with the above-described electrolyte solution.

It is generally preferable for the air electrode according to an embodiment of the invention to have a battery case which houses the air electrode, the negative electrode and the electrolyte layer. The shape of the battery case is exemplified by coin-like, flat plate-like, cylindrical and laminate shapes. The battery case may be of a type that is open to the atmosphere or may be a sealed battery case. Battery eases that are open to the atmosphere have a construction which allows at least the air electrode layer to fully come into contact with air. If the battery case is a sealed case, it is desirable to provide a gas (air) inlet and outlet in the sealed battery case. Here, the gas that is let in and let out preferably has a high oxygen concentration, and more preferably is dry air or pure oxygen. In addition, it is desirable to have the oxygen concentration be high during battery discharge and to have the oxygen concentration be low during battery recharge. Depending on the construction of the battery case, an oxygen-permeable membrane or a water-repelling membrane may be provided within the battery case.

The invention is illustrated below by way of examples, although the invention is not limited to these examples.

1. Production of Lithium-Air Battery

### EXAMPLE 1

First, each of the following materials was furnished: KB (ECP600JD, from Lion Corporation) as the conductive material, AlF₃ (from Wake Pure Chemical Industries, Ltd.) as the inorganic fluoride, and PTFE (Daikin Industries, Ltd.) as the binder. These materials were mixed in such a way that the ratio of KB to AlF₃ (KB:AlF₃) was 89 wt %:11 wt %, and the ratio of KB to AlF₃ to PTFE (KB:AlF₃:PTFE) was 80 wt %:10 wt %:10 wt %. The resulting mixture was rolled using a roll press, then dried, thereby producing an air electrode layer. A 100-mesh SUS304 stainless steel wire screen (Nilaco Corporation) was furnished as the air electrode current collector.

SUS304 stainless steel foil (Nilaco Corporation) was furnished as the negative electrode current collector and lithium metal (Honjo Metal Co., Ltd.) was laminated onto one side of the stainless used steel (SUS) foil, thereby producing a negative electrode. N,N-dimethyl-N-methyl-N-(2-methoxyethyl)ammonium bis(trifluoromethanesulfonyl)nmide (DEMETFSA, from Kanto Kagaku Co., Ltd.) was dissolved to a concentration of 0.32 mol/kg in lithium bis(trifluomethanesulfonyl)amide (Kishida Chemical Co., Ltd.), thereby forming an electrolyte solution. A polyolefin separator impregnated with this electrolyte solution was used as the electrolyte layer. This electrolyte layer was placed between the air electrode and the negative electrode in the following order, from substantially the bottom side in the gravitational direction: negative electrode current collector, lithium metal, electrolyte layer, air electrode layer, and air electrode current collector, thereby producing the lithium-air battery of Example 1. The above steps were all carried out within a glove box in a nitrogen atmosphere. The lithium-air battery of Example 1 was placed within an electrochemical cell. Pure oxygen (from Taiyo Nippon Sanso Corporation; purity, 99.9%) was introduced into the interior of the lithium-air battery of Example 1.

### EXAMPLE 2

Aside from changing the proportions of the materials in the air electrode Layer in Example 1 to: KB:AlF₃−78 wt %: 22 wt %; and KB:AlF₃:PTFE=70 wt %:20 wt %:10 wt %, an air electrode layer was produced in the same way as in Example 1. The lithium-air battery of Example 2 was produced using, as in Example 1, an air electrode layer, an air electrode current collector, a negative electrode and an electrolyte layer. Pure oxygen was introduced into the lithium-air battery of Example 2 in the same way as for the lithium-air battery of Example 1.

### COMPARATIVE EXAMPLE 1

First, KB (ECP600JD, from Lion Corporation) was furnished as the conductive material and PTFE (Daikin Industries, Ltd.) was furnished as the binder. These materials were mixed in such a way that the ratio of KB to PTFE (KB:PTFE) was 90 wt %: 10 wt %. The resulting mixture was rolled using a roll press, then dried, thereby producing an air electrode layer. That is, in Comparative Example 1, an inorganic fluoride was not used when forming the air electrode layer. Aside from this, the lithium-air battery of Comparative Example 1 was produced using, as in Example 1, an air electrode layer, an air electrode current collector, a negative electrode and an electrolyte layer. Pure oxygen was introduced into the lithium-air battery of Comparative Example 1 in the same manner as in the lithium-air battery of Example 1.

### COMPARATIVE EXAMPLE 2

Aside from changing the weight ratio of the materials in the air-electrode layer in Example 1 to KB:AlF₃=963 wt %:3.3 wt %, and KB:AlF₃:PTFE=87 wt %:3 wt %: 10 wt %, an air electrode layer was produced in the same way as in Example 1. Aside from this, the lithium-air battery of Comparative Example 2 was produced using, as in Example 1, an air electrode layer, an air electrode current collector, a negative electrode and an electrolyte layer. Pure oxygen was introduced into the lithium-air battery of Comparative Example 2 in the same manner as in the lithium-air battery of Example 1.

### COMPARATIVE EXAMPLE 3

Aside from changing the weight ratio of the materials in the air-electrode layer in Example 1 to KB:AlF₃=67 wt %:33 wt %, and KB:AlF₃:PTFE=60 wt %:30 wt %:10 wt %, an air electrode layer was produced in the same way as in Example 1. Aside from this, the lithium-air battery of Comparative Example 3 was produced using, as in Example 1, an air electrode layer, an air electrode current collector, a negative electrode and an electrolyte layer. Pure oxygen was introduced into the lithium-air battery of Comparative Example 3 in the same manner as in the lithium-air battery of Example 1.

2. I-V Measurement

The lithium-air batteries of Example 1 and 2 and of Comparative Examples 1 to 3 were placed at rest for 3 hours in a thermostatic tank at 60° C., following which the current densities were measured by carrying out I-V measurement under the following conditions. Testing apparatus: Secondary battery charge-discharge tester (BTS2004HT, from Nagano KK)
Initial applied current density: 0.01 mA/cm²
Current application time: 15 minutes
Applied current density steps: 0.02 mA/cm²
Rest time during current application: 0.1 seconds
Temperature within battery: 60° C.
Pressure within battery: 1 atmospheric pressure
Atmosphere: pure oxygen

Discharge curves for the lithium-air batteries of Examples 1 and 2 and Comparative Examples 1 to 3 are shown in FIG. 2. FIG. 2 is a graph which plots the voltage (V) on the vertical axis versus the current density (mA/cm²) on the horizontal axis. In FIG. 2, the plot indicated by triangles represents Example 1 data, the plot indicated by “X” marks represents Example 2 data, the plot indicated by diamonds represents Comparative Example 1 data, the plot indicated by squares represents Comparative Example 2 data, and the plot indicated by asterisks (*) represents Comparative Example 3 data. As shown in FIG. 2, the current density of the lithium-air battery of Comparative Example 1 which used an air electrode containing no inorganic fluoride was 0.53 mA/cm² at a voltage of 2.3 V. The current density of the lithium-air battery of Comparative Example 2 wherein the materials in the air electrode were present in a KB:AlF₃ ratio of 96.7 wt %:3.3 wt % was 0.43 mA/cm² at a voltage of 23 V. The current density of the lithium-air battery of Comparative Example 3 wherein the materials in the air electrode were present in a KB:AlF₃ ratio of 67 wt %:33 wt % was 0.51 mA/cm² at a voltage of 2.3 V. Therefore, the current densities of the lithium-air batteries of Comparative Examples 1 to 3 were less than 0.6 mA/cm² at a voltage of 2.3 V. On the other hand, as is apparent from FIG. 2, the current density of the lithium-air battery of Example 1 wherein the materials in the air electrode were present in a KB:AlF₃ ratio of 89 wt %:11 wt % was 0.65 mA/cm² at a voltage of 2.3 V. Also, the current density of the lithium-air battery of Example 2 wherein the materials in the air electrode were present in a KB:AlF₃ ratio of 78 wt %:22 wt % was 0.67 mA/cm² at a voltage of 2.3 V. Hence, the current densities of the lithium-air batteries in Examples 1 and 2 according to the invention exceeded 0.6 mA/cm² at a voltage of 2.3 V.

From the above results, it is apparent that the current densities at a voltage of 2.3 V for the lithium-air batteries of Examples 1 and 2 of the invention, which had AlF₃ ratios of from 11 to 22 wt % based on a combined amount of KB and AlF₃ of 100 wt %, were at least about 0.1 mA/cm² higher than the current density at a voltage of 2.3 V for a lithium-air battery which contained no inorganic fluoride in the air electrode (Comparative Example 1). This is presumably because including an inorganic fluoride in the air electrode increased the oxygen diffusibility within the air electrode, promoting oxygen supply within the air electrode. Moreover, the current densities at a voltage of 2.3 V for the lithium-air batteries of Examples 1 and 2 of the invention were at least about 0.2 mA/cm² higher than the current density at a voltage of 2.3 V for a lithium-air battery which had an AlF₃ content of 3.3 wt % (Comparative Example 2). Also, the current densities at a voltage of 23 V for the lithium-air batteries of Examples 1 and 2 of the invention were at least about 0.1 mA/cm² higher than the current density at a voltage of 2.3 V for a lithium-air battery which had an AlF₃ content of 33 wt % (Comparative Example 3). This demonstrates that when the content of inorganic fluoride within the air electrode is too high, the content of conductive material conversely becomes too low, lowering the battery capacity.

1. An air electrode for an air battery, comprising:
a conductive material; and
an inorganic fluoride,
wherein the inorganic fluoride is included in a ratio of from 11 to 22 wt % per 100 wt % of the conductive material and the inorganic fluoride combined.

2. The air electrode according to claim 1, wherein the air electrode further comprises a binder, and the inorganic fluoride is included in a ratio of from 10 to 20 wt % per 100 wt % of the conductive material, the inorganic fluoride and the binder combined.

3. The air electrode according to claim 1, wherein the inorganic fluoride is at least one compound selected from the group consisting of aluminum fluoride (AlF3), silicon fluoride (SiF4), iron(III) fluoride (FeF3), calcium fluoride (CaF2), magnesium fluoride (MgF2) and titanium(IV) fluoride (TiF4).

4. An air battery comprising:
the air electrode for an air battery according to claim 1,
a negative electrode; and
an electrolyte layer interposed between the air electrode and the negative electrode.

5. The air electrode according to claim 2, wherein the inorganic fluoride is at least one compound selected from the group consisting of aluminum fluoride (AlF3), silicon fluoride (SiF4), iron(III) fluoride (FeF3), calcium fluoride (CaF2), magnesium fluoride (MgF2) and titanium(IV) fluoride (TiF4).

6. An air battery comprising:
the air electrode for an air battery according to claim 2;
a negative electrode; and
an electrolyte layer interposed between the air electrode and the negative electrode.

7. An air battery comprising:
the air electrode for an air battery according to claim 3;
a negative electrode; and
an electrolyte layer interposed between the air electrode and the negative electrode.

8. An air battery comprising:
the air electrode for an air battery according to claim 5;
a negative electrode; and
an electrolyte layer interposed between the air electrode and the negative electrode.
